(19) United States
(12) Patent Application Publication
(10) Pub. No.: US 2025/0390507 A1
(43) Pub. Date: Dec. 25, 2025

(54) USER INTERFACE STATE PRESERVATION DURING ASYNCHRONOUS UPDATE

(71) Applicant: Stripe, Inc., South San Francisco, CA (US)

(72) Inventors: Aravind RAMANATHAN, Sunnyvale, CA (US); John WAHBA, SeaTac, WA (US)

(21) Appl. No.: 18/749,598

(22) Filed: Jun. 20, 2024

(51) Int. Cl. G06F 16/27; G06F 16/23; G06F 16/25; G06F 16/248

(52) U.S. Cl. CPC G06F 16/273; G06F 16/248; G06F 16/252; G06F 16/2379

(57) ABSTRACT

A records request from a search database can result in a set of records displayed at a device, when one or more records are updated at a record database, record identifiers are maintained at the device. Another records request provides the record identifiers. A search is provided based on the records request and point reads are performed on the record database based on the record identifiers. The results may be combined to remove stale data provided by the search database and use the point reads data. The combination records may be provided to the device for updating the display of the device to reflect the updated records while the search database is not yet up to date.

### TECHNICAL FIELD

The present description generally relates to tools for providing an update to data displayed at a user interface.

### BACKGROUND

Search databases may include data from several different data sources that have been aggregated and indexed so that a search query applied to the search database may run more efficiently than one or more queries to the data sources directly. The aggregation and indexing of the search database may be performed periodically so that the search database is not always up to date.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 illustrates an example network environment in which the subject technology may be implemented, in accordance with one or more embodiments.

FIG. 2 depicts an example electronic device that may implement the subject technology, in accordance with one or more embodiments.

FIG. 3 illustrates a data flow diagram for a client device, an application server, a search database, and a record database, in accordance with one or more embodiments.

FIG. 4 illustrates an example of a records reconciliation in accordance with one or more some embodiments.

FIG. 5 depicts a flow diagram of an example process for combining records from a search database and from a record database, in accordance with one or more embodiments.

FIG. 6 depicts a flow diagram of an example process for performing a search query for after a record has had an operation performed thereon, in accordance with one or more embodiments.

FIG. 7 depicts an example electronic system with which aspects of the present disclosure may be implemented, in accordance with one or more embodiments.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other embodiments. In one or more embodiments, structures and components are shown in block diagram form in order to avoid obscuring the concepts of the subject technology.

An enterprise data system can be designed to serve many different users or customers. Record databases in the enterprise data system may be designed to have distributed databases, live backup databases, and archival databases. The enterprise data system may also include one or more search databases derived from the record databases which are created or updated from the record databases. A search database can be designed to optimize search query operations and thus may represent data from the record databases with such purpose in mind. The processing required to index the record databases to derive the search database is such that the search database is only indexed periodically from the record databases. As such, if one or more of the record databases are altered, corresponding data in the search database may be stale, e.g., may not reflect the true data, until the search database is updated. Thus, a potential issue arises if a search query result provides stale data. In general, the fact that the search database may not match the record databases is not an issue because the search database will be updated in due course. When a user, however, performs a data lookup that utilizes the search database and then changes the returned results by modifying a record or deleting a record in the data lookup or changes the returned results by adding a record that would have been returned in the data lookup (either of which would result in an update to the record databases), when the data lookup is refreshed from the search database, if the search databases have not been updated, the changes made by the user may not be reflected at the user interface (e.g., computing device) from which the data lookup originated. This can lead to confusion for the user and an unpleasant user experience when working with a user interface when the data lookup does not match the writes that were just made.

Aspects of the subject technology provide a user interface mechanism so that records returned as part of a search query can be supplemented with changed records so that the returned results reflect the up-to-date information corresponding to the changed records.

Aspects of the subject technology cause a user device that makes changes to records in one or more databases to track record identifiers associated with those changed records. Then, when a request for data is made at the user device from an application server which causes a search database to be accessed by the application server, the user device can send, along with the request for data, the tracked record identifiers. The application server can then perform a query to one or more search databases based on the request for data to receive first results and then perform point lookups from one or more record databases according to each of the tracked record identifiers to receive second results. The application server can verify that the second results from the point lookups meet criteria of the request for data and modify the first results based on the second results, such as described in greater detail below.

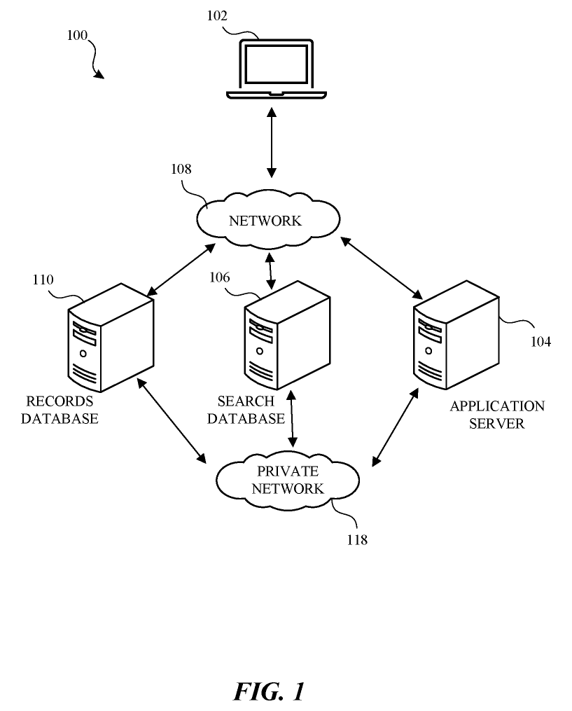

FIG. 1 illustrates an example network environment 100 in which the subject technology may be implemented, in accordance with one or more embodiments. Not all of the depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102, an application server 104, a search database 106, and a record database 110. The network 108 may communicatively (directly or indirectly) couple one or more of the electronic device 102, the application server 104, the search database 106, and the record database 110. In one or more embodiments, the network 108 may be an interconnected network of devices that may include, or may be communicatively coupled to, the internet. The application server 104 may be communicatively connected to the search database 106 and record database 110 via a private network 118 connection, as well, instead, or in combination with the network 108, as indicated in FIG. 1. In one or more embodiments, the private network 118 may be an interconnected network of devices over encrypted shared links or dedicated links that may include, or may be communicatively coupled to, the internet.

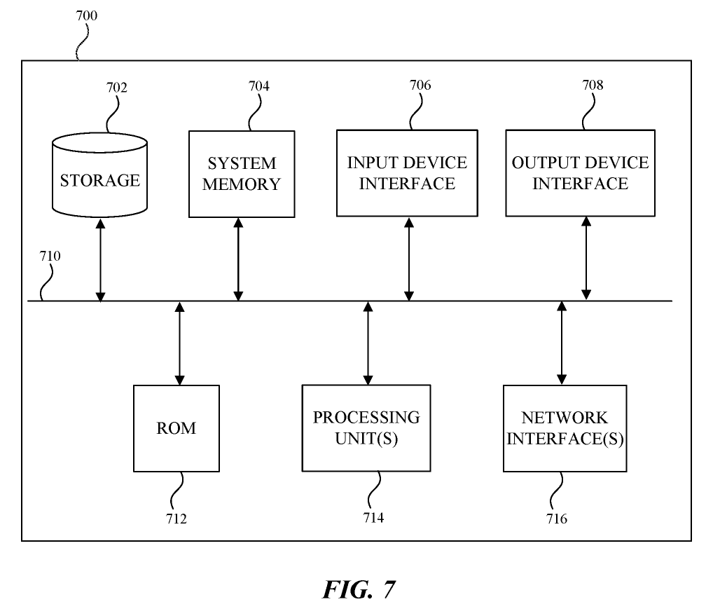

For explanatory purposes, the network environment 100 is illustrated in FIG. 1 as including the electronic device 102, the application server 104, and the search database 106, and the record database 110; however, the network environment 100 may include any number of electronic devices and/or any number of servers communicatively coupled to each other directly or via the network 108. In addition, the various systems of FIG. 1 may be, and/or may include all or part of, the electronic system discussed below with respect to FIG. 7.

The electronic device 102 may be under the control of a user with authorization to access and/or update records associated with the record database, at least by way of the application server 104. The electronic device 102 while operating as specified herein may have authorization to interact with the application server 104, for example, such as through an account login or other access credential. Thus, the electronic device 102 is used to access one or more applications which access records as described herein. The electronic device 102 may be, for example, a wearable device (such as a watch, a band, and the like), a desktop computer, a portable computing device (e.g., a laptop computer), a point of service terminal, a smartphone, a peripheral device (e.g., a digital camera, headphones), a tablet device, or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 102 is depicted as a laptop computer. The electronic device 102 may be associated with one or more accounts, credentials, or any other identity information registered with the application server 104, in accordance with some implementations.

The application server 104 may be and/or may include, for example, one or more servers that host or facilitate an application that utilizes a search database to return search query results from the search database to the electronic device 102. As an example, the application server 104 may include a transaction review module that provides users with the ability to search for transactions, view such transactions, modify or delete transactions, or create new transactions. As another example, the application server 104 may include a processing module that provides users with the ability to enter a new payment transaction and display and/or modify recent payment transactions. In some embodiments, the application server 104 may be implemented as a service of the electronic device 102. In other embodiments, the application server 104 may be, and/or may include all or part of, the electronic system discussed below with respect to FIG. 7.

The search database 106 may be and/or may include, for example, one or more servers that host or facilitate a service that may be used by one or more entities (e.g., the electronic device 102 and/or the application server 104 and/or the record database 110). The search database 106 may include one or more search databases which may be implemented in one or more servers. The search database 106 can provide responses to records requests including parameterized or natural language queries. Indexing techniques applied to the search database 106 can provide for advanced and efficient filtering and sorting on various fields, and optionally ranking the results of the filtering without burdening the record database 110. Indexing is resource intensive, and so is typically done periodically and may be done fractionally so that parts of the record database 110 are indexing independently of other parts of the record database 110.

The record database 110 may be and/or may include, for example, one or more servers that host or facilitate a service that may be used by one or more entities (e.g., the electronic device 102 and/or the application server 104 and/or the search database 106). The record database 110 may include one or more record databases, which may be implemented in one or more servers. The record database 110 can provide tracking of event data, such as transactions.

The search database 106 and record database 110 may each be, and/or may each include all or part of, the electronic system discussed below with respect to FIG. 7.

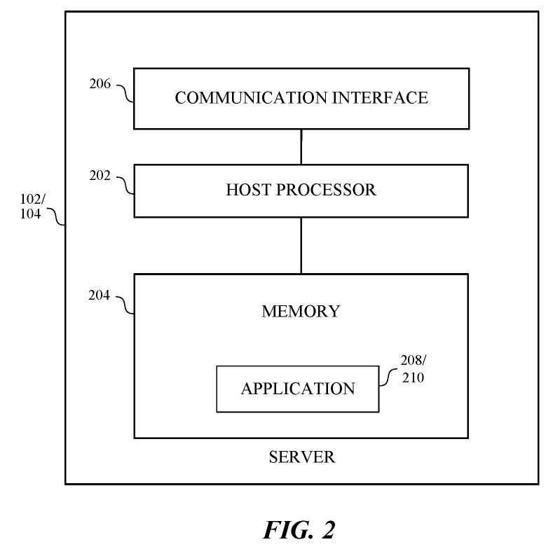

FIG. 2 depicts an example electronic device 102 or application server 104 that may implement the subject technology, in accordance with one or more embodiments. For explanatory purposes, FIG. 2 is primarily described herein with reference to the electronic device 102 or application server 104 of FIG. 1. However, this is merely illustrative, and features of the server of FIG. 2 may be implemented in any other electronic device for implementing the subject technology. Not all of the depicted components may be used in all embodiments, however, and one or more embodiments may include additional or different components than those shown in FIG. 2. Variations in the arrangement and type of the components may be made without departing from the spirit or scope of the claims as set forth herein. Additional components, different components, or fewer components may be provided.

The electronic device 102 or application server 104 may include one or more of a host processor 202, a memory 204, and/or a communication interface 206. The host processor 202 may include suitable logic, circuitry, and/or code that enable processing data and/or controlling operations of the electronic device 102 or application server 104. In this regard, the host processor 202 may be enabled to provide control signals to various other components of the electronic device 102 application server 104. The host processor 202 may also control transfers of data between various portions of the electronic device 102 or application server 104. The host processor 202 may further implement an operating system or may otherwise execute code to manage operations of the electronic device 102 or application server 104.

The memory 204 may include suitable logic, circuitry, and/or code that enable storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage). In the case of the application server 104, the memory 204 may include application 208 including executable programs, routines, and services that provide the functions described herein. In the case of the electronic device 102, the memory 204 may include application 210 including executable programs, routines, and services that provide the functions described herein. As noted above, in some embodiments, the application 210 may be incorporated in the electronic device 102 rather than a separate device.

The communication interface 206 may include suitable logic, circuitry, and/or code that enables wired or wireless communication, such as between the electronic device 102, the application server 104, the search database 106, and/or the record database 110. The communication interface 206 may include, for example, one or more of a Bluetooth communication interface, an NFC interface, a Zigbee communication interface, a WLAN communication interface, a USB communication interface, a cellular interface, or generally any communication interface.

In one or more embodiments, one or more of the host processor 202, the memory 204, the communication interface 206, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

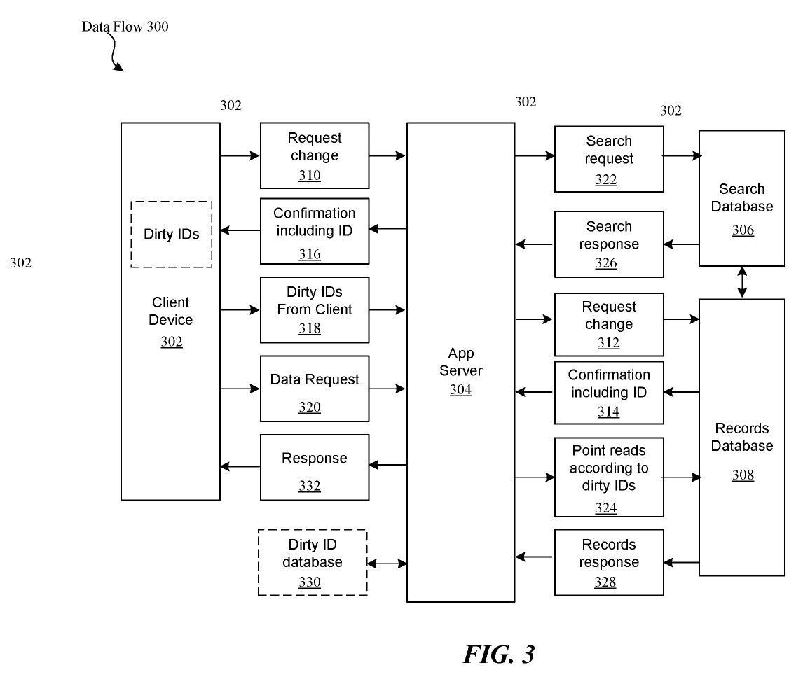

FIG. 3 illustrates a data flow diagram 300 between a client device 302 (e.g., electronic device 102), an application server 304 (e.g., application server 104), a search database 306 (e.g., search database 106), and a record database 308 (e.g., record database 110). Although the discussion of the data flow diagram 300 proceeds below describing the data flow from block to block, it should be understood that flow can be performed in parallel as appropriate or may flow out of the order described where the associated processes allow for the data flow to differ.

For the purposes of discussion, one example of an execution of the data flow of FIG. 3 may originate at a user device performing a search for payment transactions that a business conducted over the previous weekend. The payment transaction information is stored in a record database and the search database can provide an index of the record database and support searching on transaction information. The user can, via the user device, access an application server which provides an interface for transaction searching.

In accordance with some implementations, prior to the commencement of the data flow of the data flow diagram 300, the client device 302 may access, via the application server 304, an interface that provides a listing of records that originate from the search database 306. For example, a user may utilize the client device 302 to request a list of payment transactions that meet a certain criteria or filters, such as a date range, an associated payment type, a money amount, a vendor location, a customer type, and so forth. The criteria can also be further limited by the login information for a user account associated with the client device 302 making the request. For example, adding criteria based on permissions associated with the user account or based on an organization or entity associated with the user account. For example, the user can be associated with a particular location of the business and, as such, may be limited to only requesting records associated with that location. Pursuant to a request of records meeting the criteria, such as for a list of transactions denied in the previous 24 hours, a list of transactions with processing delays greater than a threshold, or a list of transactions in a particular geographic region, the records may be provided to the client device 302 and displayed at the client device 302.

Continuing the example above, a user can execute a query at the application server and retrieve a list of transactions. The application server may submit the query to the search database and then provide the results to the user. The user may have an interface provided by the application server that allows the user to sort the list so that transactions with flagged errors are sorted to the top of the interface. The user may select one of the transactions and reconcile the error, then resubmit the transaction for processing. For example, suppose that a customer’s credit card information were entered incorrectly and the user was given the correct information from the customer.

At block 310, the client device 302 can send a requested change to a data item to the application server 304. The requested change can include a requested change to information in the record database, including for example, one or more of a new record to add to the record database 308, a modified record for updating the record database 308, or an indication to delete (or make inactive) a record for updating the record database 308. The application server 304 can receive the data item and provide at block 312 the requested change to the record database 308. If the requested change is successful, at block 314, the record database 308 will return to the application server 304 an identifier for the record(s) changed, deleted, and/or added, along with a timestamp or transaction identifier for tracking that the change was made. For example, if a timestamp is used, the timestamp verifies when the last change was made to the record associated with the identifier. If a transaction identifier is used, the transaction identifier can be a number indicating a version identifier or a unique identifier that can act as a check to determine, in a conflict of records having the same record identifier, which record is newer. At block 316, the confirmation including the record identifier is provided to the client device 302. The client device 302 will store the record identifier and transaction identifier (or timestamp) in a structure of dirty identifiers. The dirty identifiers signify those identifiers which have been updated in the record database but whose status is unknown as to whether those changes have propagated to the search database 306.

Continuing the example above, the user reentering the credit card information of the customer can correct the information and submit the transaction for processing. After submitting the transaction and processing the transaction, the record database can be updated and an identifier of the record returned back to the user device. The search database, however, is not updated by the transaction processing because the indexing only takes place periodically. Thus, in the time between when the transaction takes place and when the search database is updated, the information in the search database is stale. The record identifier can be used by the user device and maintained as a dirty identifier for the remainder of the user’s session with the application server.

At this point, the record database 308 may contain information that is not found in the search database 306. The client device 302 knows which identifiers in the record database 308 are affected and cannot be trusted and maintains those as the dirty identifiers. Thus, absent the subject technology, the list of data items the client device 302 displays following the change may reflect the old data, unless the client device 302 tracks such changes locally. This can be difficult to achieve reliably for a number of reasons. First, suppose that another user makes another change to the same record, e.g., from another device, so that the record database 308 is further updated for that record. In such an instance, the locally displayed record would be inaccurate. Second, the pagination of the results may be skewed and/or records may be in an anomalous order.

To update the list of data items displayed at the client device 302 and ensure current data is reflected in the list of data items, the client device 302, at block 318 and 320, provides to the application server 304, the list of dirty identifiers at block 318 and a data request at 320. The data request can correspond, for example, to a re-request of the listing of records that meet certain criteria or filters, such as described above. The application server 304 can take the data request and formulate it as a search request at block 322 and provide the search request to the search database 306. The application server 304 can also take the list of dirty identifiers at block 318 and perform point reads from the record database 308, at block 324, based on each of the dirty identifiers in the list of dirty identifiers. The application server 304 can also optionally maintain a database or list of dirty identifiers locally or at another server, at block 330.

Continuing the example above, after submitting the transaction and obtaining the record identifier for the updated record, the user device can maintain the record identifier as a dirty identifier. Several of such operations may be made by the user and each time, the dirty identifier can be added to a list of dirty identifiers maintained by the user device. When the user device receives an update to the listed information from the application server, the update can include fresh data from both the search database and the record database. For example, the user device can provide the list of dirty identifiers to the application server. The application server will then take the dirty identifiers and receive corresponding records which are not stale from the record database, rather than from the search database. Optionally, the application server can also query the search database, for example, if the query changes or because the search database might have been updated.

In embodiments where the search database is used, the search database 306 can provide a search response, at block 326, to the application server 304. Similarly, the record database 308 can provide responses, at block 328, for each of the point reads to the application server 304.

It should be appreciated that, because the search database 306 may actually represent more than one database, the search request can provide the search request to the different search databases as appropriate to return and aggregate the search results as if coming from a single source. Similarly, because the record database 308 may actually represent more than one database, the point reads may be provided to each of their appropriate record database 308 corresponding to the record in question. Determining the record database 308 to provide the request to may be done based on the record identifier or another field specifying which record database 308 to query which is stored in connection with the dirty identifiers. Multiple point reads to a same database of the record database 308 can be grouped together and batched to the record database 308 to reduce the number of individual reads to the record database 308.

Continuing the example above, the dirty identifiers maintained by the client device, for example, from various transaction updates performed in a single session, may be sent to the application server to update the view at the user device. As noted above, the dirty identifiers signify those identifiers which have been updated in the record database but whose status is unknown as to whether those changes have propagated to the search database. Since the record database may include multiple individual databases, the dirty identifiers can be grouped together depending on which of the record databases correspond to which of the dirty identifiers. Grouping them together can result in fewer calls or point reads to the record databases because the calls can include batches of the dirty identifiers. This results in reduced processing time and less resources used than if sent individually.

The application server 304 can merge the point read data, from block 328, from the record database 308 with the search response data, from block 326, from the search database 306. The merging can compare and replace any records received from the search database 306 with records received from the record database 308. When a conflict arises between a record received from the record database 308 and a record received from the search database 306, the application server 304 can include the record from the record database 308 over the record from the search database 306. In such a manner, good data for each of the records that has been updated (according to the dirty identifiers) can be included in the merged records. When an item is received from the record database 308 which was not found in the records from the search database 306, the application server 304 can determine if the item meets the search criteria or filter that was used to search the search database 306. When the item meets the search criteria or filter, then the item can be included in the merged records. When the item does not meet the search criteria, then the item can be omitted from being included in the merged records. When an item is received from the record database 308 which indicates that the record is made inactive, is subject to deletion, or is deleted, either by the item indicating that the record is inactivated or subject to deletion or by a lack of return for a particular record identifier from the dirty identifiers, then the corresponding record may be removed when the records received from the search database 306 are merged with the records received from the record database 308.

Continuing the example above, the records returned from the record database may be merged by the application server with the search data on the application server. As noted above, the search database may also be searched, or the prior search data may be used. The Application server can merge the data from the record database with the record from the search database.

During the merging of the records or after the merging of the records, the application server 304 can apply any filtering or sorting preferences included in the data request from block 320 to the records from the search database 306 and to the records from the record database 308. As a result, one or more of the records from the record database 308 may be interspersed among records of the search database 306.

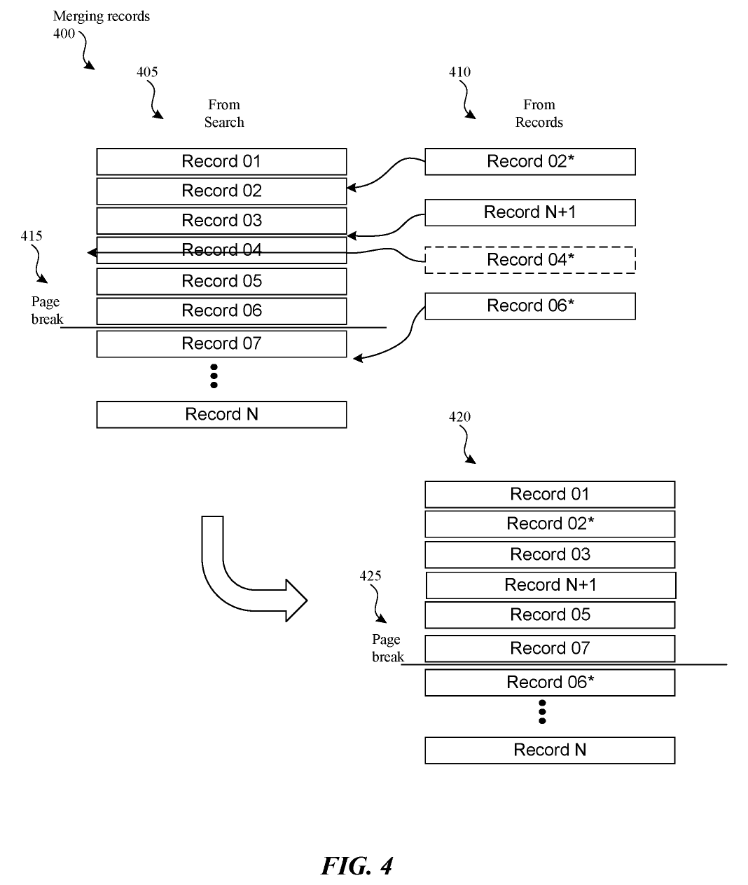

For example, turning briefly to FIG. 4, FIG. 4 illustrates merging records 400 performed by the application server 304 to merge the records from the search database 306 with the records from the record database 308. On the left, the items from search 405 are on the upper left and the items from records 410 are on the upper right. These items are records returned by each respective database, for example, from blocks 326 and 328 of FIG. 3. The items from search 405 in this example include Record 01, Record 02, Record 03, Record 04, Record 05, Record 06, Record 07, . . . Record N, for the N returned records, where the number following the word “Record” corresponds to a record identifier. The items from records 410 include Record 02*, Record N+1, Record 04*, and Record 06*, where the number following the word “Record” corresponds to the record identifier and the asterisk (*) indicates a duplicate record identifier as one in the items from search 405. It should be understood that these listings are merely examples and more or fewer records can be provided as items from records 410.

The items from search 405 may also illustrate a listing of records meeting certain criteria or filters described above just prior to where the data flow description of FIG. 3 begins. Various change, add, or delete operations may be implemented on such records, as described above. The dirty identifiers include 02, N+1, 04, and 06, which are supplied to the application server 304 along with a data request, as described above with respect to blocks 318 and 320. The search request at block 322 correspond so the data request and the dirty identifiers are used in conjunction with the point reads according to dirty identifiers at block 324. The items from search 405 correspond to the search response at block 326 and the items from records 410 correspond to the records response at block 328.

In the merging process, Record 02* from the items from records 410 is indicated as replacing the Record 02 of the items from search 405. These items have the same identifier (02), but at least because a record with the same identifier is in the items from records 410, it can be found that the Record 02* is newer and thus should replace the Record 02. A timestamp or transaction identifier or the like of each record may also be used to verify, for example, that the Record 02* is newer than the Record 02.

In the merging process, Record N+1 from the items from records 410 is indicated as being a newly added record which does not exist in the items from search 405. Further, the merging process may determine that the Record N+1 should go after the Record 03, for example, by analyzing the filter and/or sort criteria associated with the data request. Record 04* from the items from records 410 is indicated as removing and not replacing the Record 04 of the items from search 405. Record 04* may indicate, for example, that the values of Record 04 are such that it would no longer meet the filter criteria, in accordance with some embodiments. In other embodiments, Record 04* may indicate that Record 04 is marked for deletion or is hidden and should not be displayed. In yet other embodiments, the dashed box around Record 04* indicates that the Record actually did not return in the items from records 410, and as such, indicates that the Record 04 was deleted and should not be included in the merged list of records. Record 06* from the items from records 410 is indicated as replacing the Record 06 of the items from search 405. These items have the same identifier (06), but at least because a record with the same identifier is in the items from records 410, it can be found that the Record 06* is newer and thus should replace the Record 06. Further, the change in Record 06 is such that it should be reordered in the results according to the filter or sort criteria to place the Record 06 after the Record 07.

As the items from search 405 are illustrated in FIG. 4, they may include a page break 415 according to a requested pagination. Pagination can help reduce processing and transmission times of large data sets by including only the portion of the total output that is displayed. As illustrated herein for demonstration purposes, the page break is after Record 06, indicating that the pagination is six records per page in this example. Accordingly, when the set of records according to the items from search 405 are displayed on a user’s computer, the pagination causes only those items to be displayed which fall within a page break.

The merged items 420 show the final list in this demonstration. Record 01 is followed by Record 02*, which is followed by Record 03, which is followed by newly inserted Record N+1. Because Record 04 is removed from view (by deletion or modification), Record N+1 is followed by Record 05. Because Record 06 was replaced with Record 06* and it was moved as a result, Record 05 is followed by Record 07. Note that the merged items 420 include a page break 425 which in this case is also six records per pages, as described with respect to the page break 415. Due to the removal and/or reordering of items, Record 07 which was not previously displayed is now displayed.

In some implementations, rather than send the merged items 420 to the client device 302, a changelog can be sent with the changes described. In such implementations, the pagination can be set so that the initial displayed listing of records includes several records beyond the page break 415 (e.g., Record 07, Record 08, and Record 09) that are not displayed, but that are included so that a subsequently removed record (e.g., Record 04) can cause one or more of the hidden records to be used by the changelog to fill in for the missing record. In such an embodiment, the changelog can be used to provide the newly updated records, Record 02*, Record N+1, and Record 06* along with the ordering modifications to the client device 302, which then applies the changes to the data results.

Returning to FIG. 3, after the application server 304 has merged the search response from block 326 and the records response from block 328, such as described above, the application server returns the merged response at block 332. The client device 302 receives the merged records and provides them for display at the client device 302.

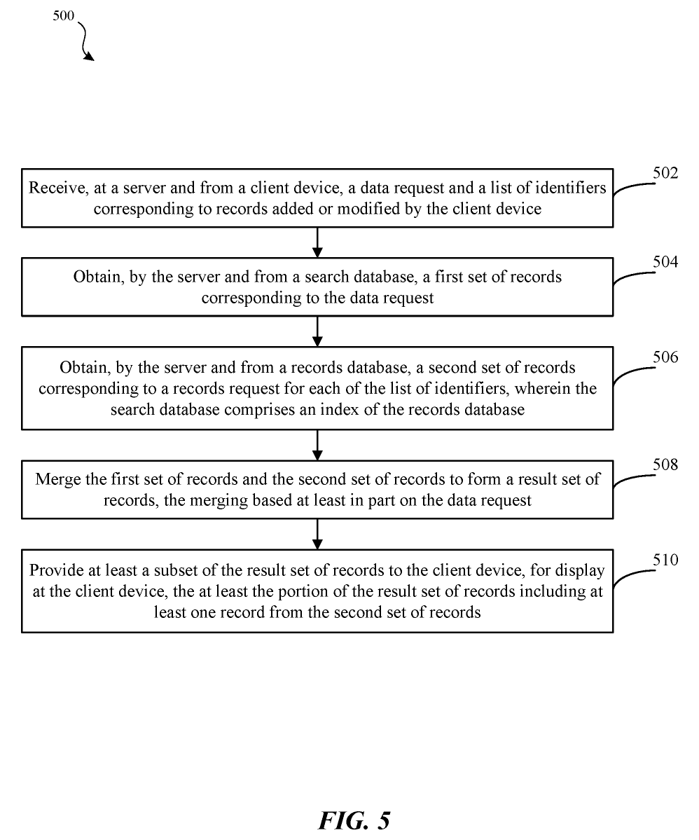

FIG. 5 illustrates a flow diagram of an example process 500 for providing from a server, such as the application server 104 or 304, a result set of records including a combination of search database records and a record database records to a client device, such as the electronic device 102 or client device 302. For explanatory purposes, the process 500 is primarily described herein with reference to the electronic device 102 and the application server 104 of FIG. 1. However, the process 500 is not limited to the electronic device 102 and the application server 104, and one or more blocks of the process 500 may be performed by one or more other by other suitable devices. Further, for explanatory purposes, the blocks of the process 500 are described herein as occurring sequentially or linearly. However, multiple blocks of the process 500 may occur in parallel. In addition, the blocks of the process 500 need not be performed in the order shown and/or one or more blocks of the process 500 need not be performed and/or can be replaced by other operations.

As shown in FIG. 5, process 500 may include, at block 502, receiving, at a server and from a client device, a data request and a list of identifiers corresponding to records added or modified by the client device. As noted above, for example, process 500 may include, for example, that the client device may provide to the server an operation instruction to modify, add, or delete a record from a record database. When the operation instruction is carried out, then record identifiers (identifiers) corresponding to the records added or modified can be provided to the client device. In addition, a timestamp corresponding to the record which is added or modified may also be provided to the client device. Then, at block 502, the server can receive the data request and the record identifiers corresponding to the records added or modified (including changed, hidden, or deleted).

At block 504, process 500 may include obtaining, by the server and from a search database, such as the search database 106 or 306, a first set of records corresponding to the data request. In other words, the data request can be used by the server to obtain, from the search database, a list of records which satisfy the data request from the data in the search database. However, because some of the data may have changed, the results from the data request may contain old or stale data corresponding to the records which were updated but not yet reindexed by the search database. At block 506, process 500 may include obtaining, by the server and from a record database, a second set of records corresponding to a records request for each of the list of identifiers, where the search database comprises an index of the record database. The list of identifiers received at block 502 can be used to perform read requests on the record database to obtain record information corresponding to the list of identifiers. In some embodiments, the record database may include a first record database and a second record database. In such embodiments, the list of identifiers may be separated to include those associated with the first record database for querying the first record database in a first batch query, and to include those associated with the second record database for querying the second record database in a second batch query. In one embodiment, the first set of records may include a first record corresponding to a first identifier from the list of identifiers, and merging the first set of records and the second set of records includes forgoing using the first record from the first set of records and instead using a second record corresponding to the first identifier from the second set of records. In some embodiments, storing the list of identifiers in an identifier database, and removing an identifier from the identifier database when the search database is updated may be performed to track at the sever which identifiers have had their records altered to preserve state.

At block 508, process 500 may include merging the first set of records and the second set of records to form a result set of records, the merging based at least in part on the data request. For example, as explained above with respect to FIGS. 3 and 4, the two sets of records, such as the items from search and the items from records may be merged together. The merging can replace some of the records data from the items from search, for example, for those records in the items from search including an identifier from the list of identifiers. The merging can also utilize filter criteria used in the search to filter or organize the merged items. For example, in some embodiments, the data request may include a filter criteria, where the one or more records in the second set of records are interspersed among the records of the first set of records according to the filter criteria. Also, in some embodiments, merging the first set of records and the second set of records disposes one or more records in the second set of records to be interspersed among the records of the first set of records. In such embodiments, merging the first set of records and the second set of records can include removing, from the first set of records, a record corresponding to a first identifier of the list of identifiers which is absent from the second set of records due to not meeting the filter criteria.

In some embodiments, process 500 may further include comparing, from the second set of records, each record having a corresponding record in the first set of records with the corresponding record; and selecting to include in the result set of records the corresponding record from the second set of records when a timestamp from the corresponding record in the second set of records is more recent than a timestamp from the corresponding record in the first set of records. In some embodiments, process 500 further includes when the corresponding record from each of the first set of records and the second set of records has the same timestamp, providing an indication to the client device that the corresponding record is updated in the search database. For example, the server can provide a list of identifiers back to the client device, with the identifier removed which corresponds to the record which is updated in the search database, thereby indicating to the client device that the corresponding record has been indexed as part of the search database.

At block 510, process 500 may include providing at least a subset of the result set of records to the client device, for display at the client device, the at least the portion of the result set of records including at least one record from the second set of records. The merged list, for example, can be provided to the client device for display. When the merged list exceeds a pagination setting for the client device, then only a subset of the result set of records may be sent to the client device for display. Also, in some embodiments, such as when a changelog is sent to the client device to effectuate the record change, the subset of records may include a number of records in excess of a pagination requested by the client device.

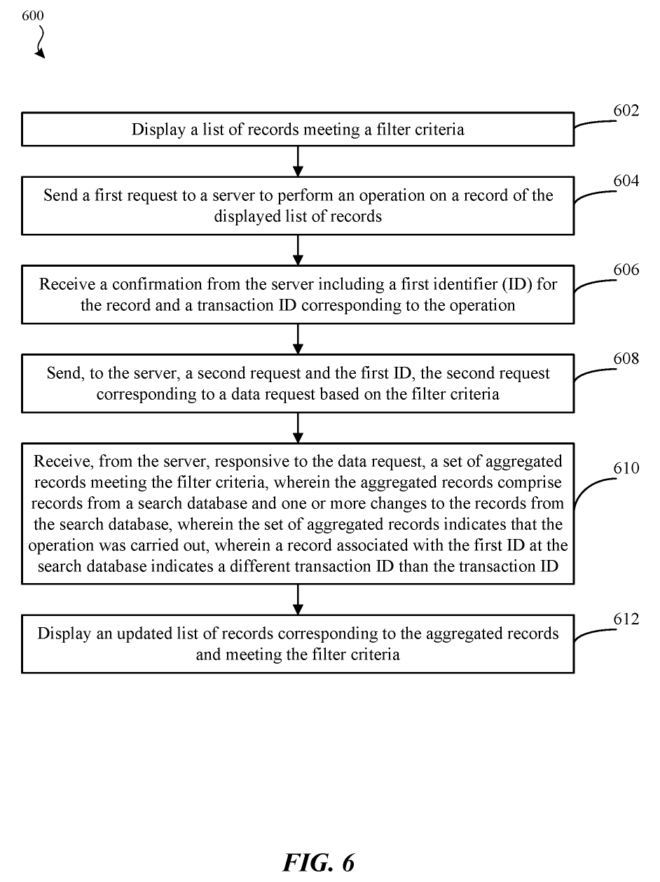

FIG. 6 illustrates a flow diagram of an example process 600 for displaying a list of records at a user device, such as the electronic device 102 or client device 302, updating one or more records via a server, such as an application server 104 or 304, and receiving data from an application server which is an aggregation of results from a search database and results from retrieving changed records from a record database. For explanatory purposes, the process 600 is primarily described herein with reference to the electronic device 102 and the application server 104 of FIG. 1. However, the process 600 is not limited to the electronic device 102 and the applications server 104, and one or more blocks of the process 600 may be performed by one or more other by other suitable devices. Further, for explanatory purposes, the blocks of the process 600 are described herein as occurring sequentially or linearly. However, multiple blocks of the process 600 may occur in parallel. In addition, the blocks of the process 600 need not be performed in the order shown and/or one or more blocks of the process 600 need not be performed and/or can be replaced by other operations.

As shown in FIG. 6, at block 602, process 600 may include displaying a list of records meeting a filter criteria. For example, the user device can send a request to an application server to query a search database according to some filter criteria. The results of the query can be provided back to the user device. The user device can then display a list of records corresponding to the results.

At block 604, process 600 may include sending a first request to a server to perform an operation on a record of the displayed list of records. As described above, the user device can request an operation to be performed on one or more records which are displayed as the list of records. The operation may be a modification request or a deletion, for example. Additional operations may be performed to add a record, for example, by entering a transaction at the user device.

At block 606, process 600 may include receiving a confirmation from the server including a first identifier for the record and a transaction identifier corresponding to the operation. The transaction identifier may be stored in association with the first identifier after the operation is performed, for example, in the record database. The first identifier and transaction identifier may signify a confirmation that a corresponding operation on a record identified by the first identifier was performed on a record database which holds the primary versions of the records and from which the search database is indexed periodically. The transaction identifier may correspond to a unique code which provides a data point that signifies that the record associated with the first identifier was updated. In some embodiments, the transaction identifier may correspond to a timestamp, for example. The user device may store the first identifier at the user device, for example, along with other identifiers, such as a list of identifiers including the first identifier and a second identifier corresponding to other changed records. In some embodiments, the first identifier and/or list of identifiers may be stored in a browser cookie, such as a session cookie.

At block 608, process 600 may include sending, to the server, a second request and the first identifier, the second request corresponding to a data request based on the filter criteria. The second request may have the same filter criteria as the first request, but it could different as well. When the user makes the second request, not all of the records in the search database which meet the filter criteria are necessarily be up to date. As such, if the results were returned from the search database a change just made by a user of the user device would not reflect be reflected in the results from the second request. For example, the user device may send to the server a second request and the first identifier (along with additional identifiers in a list of identifiers, as appropriate). When the list of identifiers exceeds a predefined number of identifiers as a threshold number of identifiers being tracked for point reads against the record database, then the oldest included identifier can be removed from the list until the number of identifiers is within the threshold. Effectively, this presumes the oldest identifiers would have been updated in the search database.

At block 610, process 600 may include receiving, from the server, responsive to the data request, a set of aggregated records meeting the filter criteria, where the aggregated records comprise records from a search database and one or more changes to the records from the search database, where the set of aggregated records indicates that the operation was carried out, where a record associated with the first identifier at the search database indicates a different transaction identifier than the transaction identifier. Thus, the aggregated records include some records from a search database that is updated periodically, asynchronously from the record database, and some records from a record database based on the first identifier (and other identifiers which are stored as indicating that some change was made). In some embodiments, the set of aggregated records includes a record corresponding to the first identifier, the record including the transaction identifier. In some embodiments, an indication may be received from the server that the search database has been updated with respect to a second identifier of the list of identifiers and the user device may remove the second identifier from the list of identifiers. For example, in addition to the aggregated records, the server may send the list of identifiers back to the user device. The server may reconcile that one or more identifiers in the list of identifiers corresponds to a record which was updated and which update has propagated to the search database. As such, it is not needed to be kept in the list of identifiers any more. The server can update the list of identifiers and return the list of identifiers to replace the list of identifiers stored by the user device.

At block 612, process 600 may include displaying an updated list of records corresponding to the aggregated records and meeting the filter criteria. The updated list of records may include only the aggregated records which meet the filter criteria. In addition, in some embodiments a portion of the aggregated records are displayed according to a pagination scheme. In accordance with some embodiments, the operation includes deleting the record, where after receiving the confirmation the displayed list of records is updated to remove the record from the display and include an additional record meeting the filter criteria. For example, a record may be stored in memory, but not displayed. Upon removing the record, the pagination can be updated to include the next record which would have been displayed. In accordance with some embodiments, the operation comprises modifying a record, where after receiving the confirmation, the displayed list of records is updated to reorganize the list to reflect the modified record. In accordance with some embodiments, the operation comprises to add a record, where after receiving the confirmation, the displayed list of records is updated to remove a last displayed record and insert the added record among the displayed list of records.

FIG. 7 depicts an example electronic system 700 with which aspects of the present disclosure may be implemented, in accordance with one or more embodiments. The electronic system 700 can be, and/or can be a part of, any electronic device for generating the features and processes described in reference to FIGS. 1-6, including but not limited to a laptop computer, tablet computer, smartphone, and wearable device (e.g., smartwatch, fitness band). The electronic system 700 may include various types of computer-readable media and interfaces for various other types of computer-readable media. The electronic system 700 includes one or more processing unit(s) 714, a persistent storage device 702, a system memory 704 (and/or buffer), an input device interface 06, an output device interface 708, a bus 710, a ROM 712, one or more processing unit(s) 714, one or more network interface(s) 716, and/or subsets and variations thereof.

The bus 710 collectively represents all system, peripheral, and chipset buses that communicatively connect the numerous internal devices of the electronic system 700. In one or more embodiments, the bus 710 communicatively connects the one or more processing unit(s) 714 with the ROM 712, the system memory 704, and the persistent storage device 702. From these various memory units, the one or more processing unit(s) 714 retrieves instructions to execute and data to process in order to execute the processes of the subject disclosure. The one or more processing unit(s) 714 can be a single processor or a multi-core processor in different embodiments.

The ROM 712 stores static data and instructions that are needed by the one or more processing unit(s) 714 and other modules of the electronic system 700. The persistent storage device 702, on the other hand, may be a read-and-write memory device. The persistent storage device 702 may be a non-volatile memory unit that stores instructions and data even when the electronic system 700 is off. In one or more embodiments, a mass-storage device (such as a magnetic or optical disk and its corresponding disk drive) may be used as the persistent storage device 702.

In one or more embodiments, a removable storage device (such as a floppy disk, flash drive, and its corresponding disk drive) may be used as the persistent storage device 702. Like the persistent storage device 702, the system memory 704 may be a read-and-write memory device. However, unlike the persistent storage device 702, the system memory 704 may be a volatile read-and-write memory, such as RAM. The system memory 704 may store any of the instructions and data that one or more processing unit(s) 714 may need at runtime. In one or more embodiments, the processes of the subject disclosure are stored in the system memory 704, the persistent storage device 702, and/or the ROM 712. From these various memory units, the one or more processing unit(s) 714 retrieves instructions to execute and data to process in order to execute the processes of one or more embodiments.

The bus 710 also connects to the input device interfaces 706 and output device interfaces 708. The input device interface 706 enables a user to communicate information and select commands to the electronic system 700. Input devices that may be used with the input device interface 706 may include, for example, alphanumeric keyboards, touch screens, and pointing devices. The output device interface 708 may enable the electronic system 700 to communicate information to users. For example, the output device interface 708 may provide the display of images generated by electronic system 700. Output devices that may be used with the output device interface 708 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more embodiments may include devices that function as both input and output devices, such as a touchscreen. In these embodiments, feedback provided to the user can be any form of sensory feedback, such as visual feedback, auditory feedback, or tactile feedback; and input from the user can be received in any form, including acoustic, speech, or tactile input.

The bus 710 also couples the electronic system 700 to one or more networks and/or to one or more network nodes through the one or more network interface(s) 716. In this manner, the electronic system 700 can be a part of a network of computers (such as a local area network, a wide area network, an intranet, or a network of networks, such as the internet). Any or all components of the electronic system 700 can be used in conjunction with the subject disclosure.

Embodiments within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more embodiments, the tangible computer-readable storage medium can be directly coupled to a computing device, while in other embodiments, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more embodiments are performed by one or more integrated circuits, such as ASICs or FPGAs. In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be re-arranged, or that all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together into a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, an embodiment, the embodiment, another embodiment, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method, comprising:
receiving, at a server and from a client device, a data request and a list of identifiers corresponding to records added or modified by the client device;
obtaining, by the server and from a search database, a first set of records corresponding to the data request;
obtaining, by the server and from a record database, a second set of records corresponding to a record request for each of the list of identifiers, wherein the search database comprises an index of the record database;
merging the first set of records and the second set of records to form a result set of records, the merging based at least in part on the data request; and
providing at least a subset of the result set of records to the client device, for display at the client device, the subset of the result set of records including at least one record from the second set of records.

2. The method of claim 1, wherein the search database is updated asynchronously as an index of the record database after the record database is updated.

3. The method of claim 1, wherein merging the first set of records and the second set of records causes one or more records in the second set of records to be interspersed among the records of the first set of records.

4. The method of claim 3, wherein the data request includes a filter criteria, wherein the one or more records in the second set of records are interspersed among the records of the first set of records according to the filter criteria.

5. The method of claim 1, wherein the data request includes a filter criteria, wherein merging the first set of records and the second set of records includes removing, from the first set of records, a record corresponding to a first identifier of the list of identifiers which is absent from the second set of records due to not meeting the filter criteria.

6. The method of claim 1, wherein the record database includes a first record database and a second record database, further comprising:
associating a subset of the list of identifiers associated with the first record database for querying the first record database in a first batch query; and
associating a second subset of the list of identifiers associated with the second record database for querying the second record database in a second batch query.

7. The method of claim 1, further comprising:
receiving a request from the client device to add or modify a record; and
returning to the client device, an identifier and a timestamp corresponding to the record which is added or modified, wherein the identifier is included in the list of identifiers received at the server.

8. The method of claim 1, further comprising:
comparing, from the second set of records, each record in the second set of records having a corresponding record in the first set of records with the corresponding record from the first set of records; and
selecting to include in the result set of records the corresponding record from the second set of records when a timestamp from the corresponding record in the second set of records is more recent than a timestamp from the corresponding record in the first set of records.

9. The method of claim 8, further comprising:
when the corresponding record from each of the first set of records and the second set of records has the same timestamp, providing an indication to the client device that the corresponding record is updated in the search database.

10. A method comprising:
displaying a list of records meeting a filter criteria;
sending a first request to a server to perform an operation on a record of the displayed list of records; receiving a confirmation from the server including a first identifier for the record and a transaction identifier corresponding to the operation;
sending, to the server, a second request and the first identifier, the second request corresponding to a data request based on the filter criteria; receiving, from the server, responsive to the data request, a set of aggregated records meeting the filter criteria, wherein the aggregated records comprise records from a search database and one or more changes to the records from the search database, wherein the set of aggregated records indicates that the operation was carried out, wherein a record associated with the first identifier at the search database indicates a different transaction identifier than the transaction identifier; and displaying an updated list of records corresponding to the aggregated records and meeting the filter criteria.

11. The method of claim 10, wherein the transaction identifier is stored in association with the first identifier after the operation is performed.

12. The method of claim 10, wherein the set of aggregated records includes a record corresponding to the first identifier, the record including the transaction identifier.

13. The method of claim 10, wherein a list of identifiers includes the first identifier and a second identifier, further comprising:
sending, with the second request, the list of identifiers;
receiving an indication from the server that the search database has been updated with respect to the second identifier; and
removing the second identifier from the list of identifiers.

14. The method of claim 10, wherein sending the second request and the first identifier includes sending a list of identifiers, the list of identifiers including the first identifier, wherein when a number of identifiers in a list of identifiers does not meet a first threshold, removing an oldest identifier from the list of identifiers as many times as necessary to meet the first threshold.

15. The method of claim 10, wherein first identifier is stored in a session cookie.

16. The method of claim 10, wherein the operation comprises modifying a record, wherein after receiving the confirmation, the displayed list of records is updated to reorganize the list to reflect the modified record.

17. A device comprising:
a processor; and
a computer-readable medium storing instructions thereon, which when executed by the processor, cause the processor to:
receive, at a server and from a client device, a data request and a list of identifiers corresponding to records added or modified by the client device;
obtain, by the server and from a search database, a first set of records corresponding to the data request;
obtain, by the server and from a record database, a second set of records corresponding to a records request for each of the list of identifiers, wherein the search database comprises an index of the record database;
merge the first set of records and the second set of records to form a result set of records, the merging based at least in part on the data request; and
provide at least a subset of the result set of records to the client device, for display at the client device, the subset of the result set of records including at least one record from the second set of records.

18. The device of claim 17, wherein the search database is updated asynchronously as an index of the record database after the record database is updated, and wherein the data request includes a filter criteria, wherein the one or more records in the second set of records are interspersed among the records of the first set of records according to the filter criteria.

19. The device of claim 17, wherein the instructions further cause the processor to:
receive a request from the client device to add or modify a record; and
return to the client device, an identifier and a timestamp corresponding to the record which is added or modified, wherein the identifier is included in the list of identifiers received at the server.

20. The device of claim 17, wherein the instructions further cause the processor to:
compare, from the second set of records, each record in the second set of records having a corresponding record in the first set of records with the corresponding record from the first set of records; and
select to include in the result set of records the corresponding record from the second set of records when a timestamp from the corresponding record in the second set of records is more recent than a timestamp from the corresponding record in the first set of records.
